(19) United States
(12) Patent Application Publication
(10) Pub. No.: US 2025/0382829 A1
(43) Pub. Date: Dec. 18, 2025

(54) FIRE RATED LATCH MECHANISMS

(71) Applicant: ASSA ABLOY Accessories and Door Controls Group, Inc., New Haven, CT (US)

(72) Inventors: Matthew Donaldson, Meyersdale, PA (US); Kyle R. Murray, Somerset, PA (US); Sam Wiedner, Friedens, PA (US); Heather Faircloth, Somerset, PA (US)

(73) Assignee: ASSA ABLOY Accessories and Door Controls Group, Inc., New Haven, CT (US)

(21) Appl. No.: 19/240,153

(22) Filed: Jun. 17, 2025

Related U.S. Application Data
(60) Provisional application No. 63/661,448, filed on Jun. 18, 2024.

(51) Int. Cl. E05B 65/10

(52) U.S. Cl. CPC E05B 65/1006; E05B 65/1053

(57) ABSTRACT

According to some embodiments, a latch mechanism configured to be secured to a door is provided. The latch mechanism may include a latch bolt that is movable between a latched position and a retracted position, and the latch bolt may be configured to engage a corresponding door strike when in the latched position. The latch mechanism may also include one or more deployable pins configured to move to a deployed position in response to being exposed to a threshold temperature such that the deployable pins may retain the latch bolt in the latched position when the deployable pins are in the deployed position.

### CROSS REFERENCE TO RELATED APPLICATIONS

This application claims the benefit under 35 U.S.C. § 119(e) to U.S. Provisional Application Ser. No. 63/661,448, filed Jun. 18, 2024, which is incorporated herein by reference in their entirety.

### FIELD

Disclosed embodiments are related to fire rated latch mechanisms configured for use with access control devices, such as door locks and exit devices.

### BACKGROUND

Conventional latch mechanisms may be employed for use in exit devices and other door lock mechanisms to hold a door in a locked position or an unlocked position by moving a latch bolt between a latched position and a retracted position, respectively. Exit devices are commonly installed on high traffic commercial doors for use as a primary opening mechanism. Such exit devices generally include a depressible push bar that translates the pushing of the bar by a user into movement of the latch bolt to the retracted position.

### SUMMARY

In some embodiments, a latch mechanism configured to be secured to a door is provided. The latch mechanism may include a latch bolt that is movable between a latched position and a retracted position, where the latch bolt is configured to engage a corresponding door strike when in the latched position. The latch mechanism may also include one or more deployable pins configured to move to a deployed position in response to the latch mechanism being exposed to a threshold temperature. In some embodiments, the one or more deployable pins may be configured to retain the latch bolt in the latched position when the one or more deployable pins are in the deployed position.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a perspective view of one embodiment of a door including an exit device;

FIG. 2A is a perspective schematic view of a latch mechanism configured for use with the exit device of FIG. 1 where the latch mechanism is located in region 2A of FIG. 1, according to some embodiments;

FIG. 2B is a perspective schematic view of a latch bolt of the latch mechanism of

FIG. 2A, according to some embodiments;

FIG. 2C is a cross-sectional schematic view of the latch bolt of FIG. 2B taken along lines 2C-2C, according to some embodiments

FIG. 2D is the cross-sectional schematic view of FIG. 2C, where an intumescent material configured for use as a deployment mechanism is additionally shown;

FIG. 2E is the cross-sectional schematic view of FIG. 2C, where a biasing member configured for use as a deployment mechanism is additionally shown; and

FIG. 3 is a cross-sectional schematic view of a latch mechanism, according to some embodiments.

### DETAILED DESCRIPTION

Latch mechanisms are commonly found throughout commercial, residential, and industrial buildings and are used to hold doors in a locked state or an unlocked state depending on the position of the latch bolt. That is, a latch bolt of the latch mechanism may be extended into or retracted from a corresponding door strike to hold the door in a locked state or an unlocked state, respectively. Such latch mechanisms may be configured for use within exit devices or other suitable door lock mechanisms. For example, exit devices such as vertical latching exit devices may include push bars which are depressible by a user to open associated doors by retracting a latch bolt from a corresponding door strike in response to actuation of the push bars.

The inventors have recognized that during an elevated temperature event (e.g., a fire), it may be desirable to maintain the latch bolt in the extended, latched position to hold doors in a locked state to prevent the doors from being opened and to contain fire, smoke, or other hazards. However, the inventors have appreciated that common latch mechanisms may not have the capability to maintain the door in a locked state in response to being exposed to an elevated temperature event.

In view of the above, the inventors have recognized benefits associated with providing a latch mechanism that is able to maintain a corresponding door in a locked state in response to being exposed to a certain temperature threshold. In particular, the inventors have recognized benefits associated with providing one or more deployable pins in a latch mechanism that may deploy when the latch mechanism is exposed to a threshold temperature to retain a latch bolt in a latched position.

In some embodiments, the deployable pins may be deployed using any suitable deployment mechanism including, but not limited to, intumescent materials, biasing members (e.g., springs), actuators (e.g., electromechanical actuators, pneumatic actuators, piezoelectric actuators, etc.), or any other suitable deployment mechanism as the disclosure is not so limited. For example, an intumescent material may be positioned adjacent to the one or more deployable pins, and the intumescent material may swell in response to being exposed to a threshold temperature, thus moving the pins to a deployed configuration. In some embodiments, a suitable intumescent material may be constructed out of carbonaceous foam, sodium silicates, graphite, or any other suitable intumescent material as the disclosure is not so limited.

In some embodiments, the one or more deployable pins may be retained in a non-deployed configuration by one or more blocking elements (hereinafter referred to as “blockers”), and the one or more deployable pins may be biased to move to the deployed position following degradation of the one or more blockers. For example, the one or more blockers may be configured to melt in response to being exposed to a threshold temperature, and the one or more deployable pins may be biased to move to the deployed position (e.g., via an intumescent material or a spring positioned adjacent the deployable pins) once the blockers melt such that the pins retain a corresponding latch bolt in a latched position.

In some embodiments, the one or more deployable pins may include one or more protuberances extending from the pin. The protuberances may be integrally formed with the pin or separately constructed and then attached to the pin as the disclosure is not so limited. In some embodiments, the one or more protuberances may be configured to engage one or more blockers to retain the pins in the non-deployed position absent degradation of the one or more blockers and/or the one or more protuberances. For example, in addition or alternatively to the one or more blockers being configured to melt in response to being exposed to a threshold temperature, the one or more protuberances may be configured to melt in response to being exposed to a threshold temperature to allow for the one or more deployable pins to move to a deployed position.

In some embodiments, the one or more deployable pins may be received within a housing that may at least partially surround the latch bolt of the latch mechanism. In some embodiments, the housing may include one or more recesses configured to receive the one or more deployable pins, the one or more blockers, and/or the one or more protuberances extending from the pins. In some embodiments, the one or more blockers may be formed integrally with the housing. Alternatively, the one or more blockers may be constructed separately and then attached to the housing.

As discussed above, the one or more deployable pins may move to the deployed position in response to the melting of blockers and/or protuberances extending from the deployable pins, and/or in response to activation of a deployment mechanism. However, in some embodiments, at least one of the blockers and the protuberances may not be provided with the latch mechanism. In some such embodiments, the deployment mechanism may solely cause the deployable pins to deploy (e.g., via swelling of an intumescent material) rather than via the melting of blockers and/or protuberances extending from the deployable pins. For example, the deployable pins may not include protuberances and instead may be held via an interference fit in the recesses of the housing, and the deployment mechanism may be activated to overcome the interference fit to move the deployable pins to the deployed position. In another example, deployable pins may include protuberances, and the protuberances may be breakable, meltable, etc., such that activation of the deployment mechanism degrades the protuberances to move the deployable pins to the deployed position.

Any suitable number of deployable pins may be provided in a latch mechanism according to the embodiments disclosed herein. In some embodiments, two deployable pins may be employed, though 1 or 4 or any suitable number of deployable pins may be employed. In addition, any suitable number of blockers may be provided to retain the deployable pins in a non-deployed state. In some embodiments, a suitable number of blockers may be 2 blockers, though 1 or 4 or any suitable number of blockers may be employed. In some embodiments, each deployable pin may have a singular corresponding blocker. In other embodiments, however, at least one of the deployable pins may have more than one corresponding blockers. Moreover, the deployable pins may include any suitable number of protuberances extending therefrom, e.g., 1, 2, or more protuberances. In some embodiments, the number of protuberances on a deployable pin may be selected according to the number of blockers provided in the latch mechanism, e.g., each blocker may abut a corresponding protuberance on a deployable pin in the non-deployed configuration. In some embodiments, the deployable pins may include two deployable pins, and the deployable pins may be positioned opposite one another. Such a configuration may serve to provide a balanced retaining force on the latch bolt when the pins are deployed to keep the latch bolt in the latched position.

In some embodiments, a suitable threshold temperature that may cause the one or more deployable pins to move to the deployed position may be between or equal to 125° F. and 300° F., although threshold temperatures both greater and lesser than this range are also contemplated. In some embodiments, the one or more deployable pins may be configured to deploy at a threshold temperature of approximately 230° F.

The deployable pins may be constructed out of any suitable material including, but not limited to, metals such as aluminum, stainless steel, carbon steel, brass, nickel, or iron, metal alloys, high melting temperature plastics (e.g., polytetrafluoroethylene, polyether ether ketone, etc.), or any other suitable material as the disclosure is not so limited. The blockers and/or protuberances connected to the deployable pins may be constructed out of any suitable material including, but not limited to, wax, plastics (e.g., polyethylene, polypropylene, etc.), low melting temperature metals or alloys (e.g., fusible alloys), nylon, or any other suitable material as the disclosure is not so limited.

Although the embodiments disclosed herein are primarily discussed in reference to top latching exit devices, the embodiments disclosed herein may be configured for use in any door lock mechanism. For example, the embodiments disclosed herein may be applied to side latching exit devices, bottom latching exit devices, mortise locks, deadbolts, knob locks, or any other suitable door lock mechanism as the disclosure is not so limited.

In some embodiments, a door lock mechanism (e.g., an exit device) may include a single latch bolt that is moveable between a latched position and a retracted position, and the latch bolt may be engageable with a corresponding door strike when the latch bolt is in the latched position. For example, the latch bolt of the exit device may be configured to engage a door strike located in the head jamb of a door. In some embodiments, a door lock mechanism may include a plurality of latch bolts that are moveable between a latched position and a retracted position. For example, the plurality of latch bolts may include two latch bolts that are configured to engage a door strike located in each of the head jamb and the threshold. While such examples are disclosed, the exit device may include any suitable arrangement of latches (e.g., a head jamb latch, a threshold latch, a side jamb latch, etc.) to engage with corresponding portions of a door (e.g., a head jamb, a threshold, a side jamb, etc.). In some embodiments, each of the plurality of latch bolts may include one or more deployable pins configured to deploy to retain the latch bolt in the latched position when the deployable pins are exposed to a threshold temperature.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

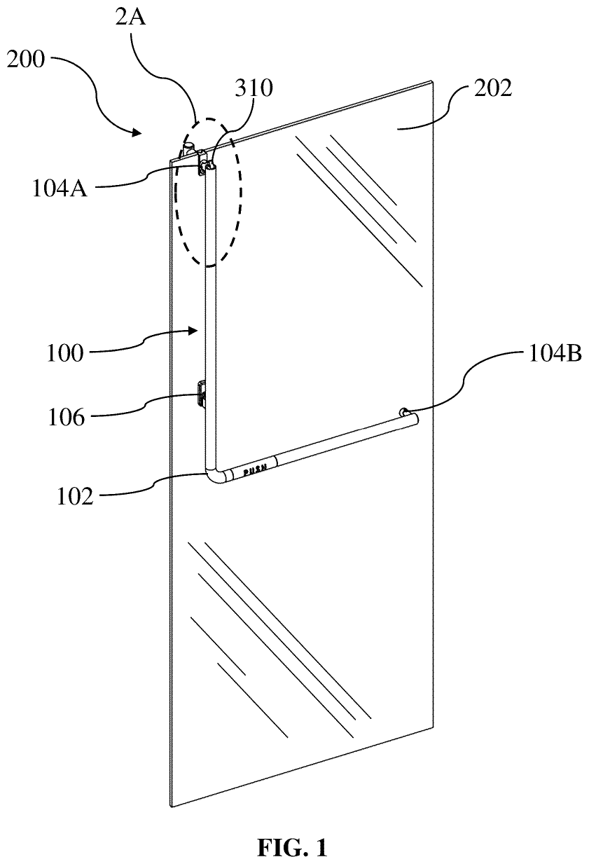

FIG. 1 is a perspective view of an embodiment of a door 200 including an exit device 100. As shown in FIG. 1, the exit device is a low profile exit device which does not substantially obscure a door panel 202. The exit device includes a first hinge 104A, a second hinge 104B, and a door actuator 106 which function as interfacing points between the exit device and the door, so that the majority of the door panel remains uncovered. A push bar chassis 102 is suspended from the first hinge and the second hinge and serves as a push bar to allow a user to operate the door. The exit device 100 includes a latch bolt 310 which projects from a top of the chassis and secures the door in an associated door frame when the latch bolt is in the latched (i.e., extended) position. According to the embodiment of FIG. 1, when the chassis 102 is pushed toward the door panel, the door actuator 106 engages a latch actuator (not shown) disposed in the chassis to move the latch bolt 310 to the unlatched (i.e., retracted) position to release the door. As the chassis is pushed by the user, the push bar rotates about the first hinge 104A and the second hinge 104B to bring a portion of the push bar nearer the door actuator 106 closer to the door panel. The latch actuator may be configured to transmit substantially linear relative motion between the chassis 102 and the door actuator 106 into motion of the latch bolt 310. The latch actuator may include a transmission which may convert the push motion on the chassis 102 into vertical motion of a vertical rod that may be operatively coupled to the latch actuator on a first end and operatively coupled to the latch 130 on a second end. In some embodiments, the latch bolt 310 may be biased towards the latched position with a spring or other biasing member such that the latch bolt is retained in the latched position absent a pushing force on the chassis 102. The exit device 100 may be installed on a door formed of any material or combination of materials, such as wood, metal, plastic, fiberglass, and/or glass.

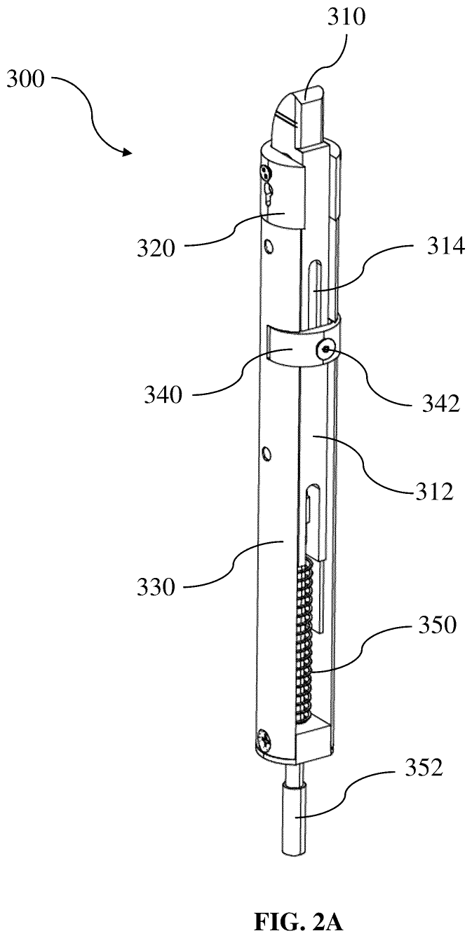

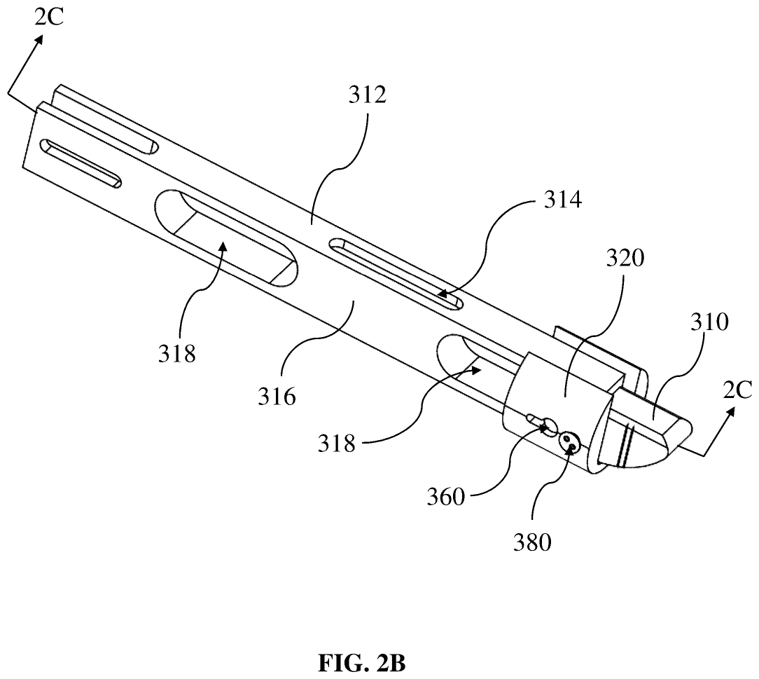

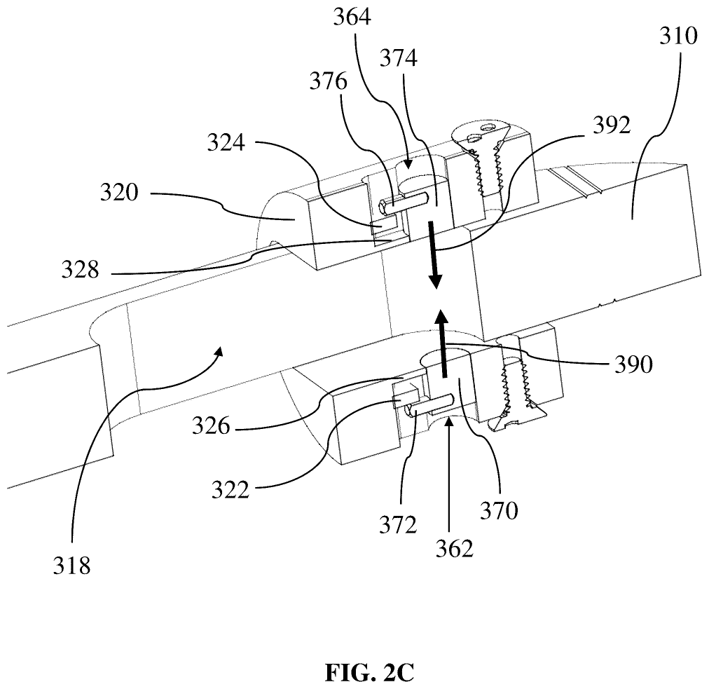

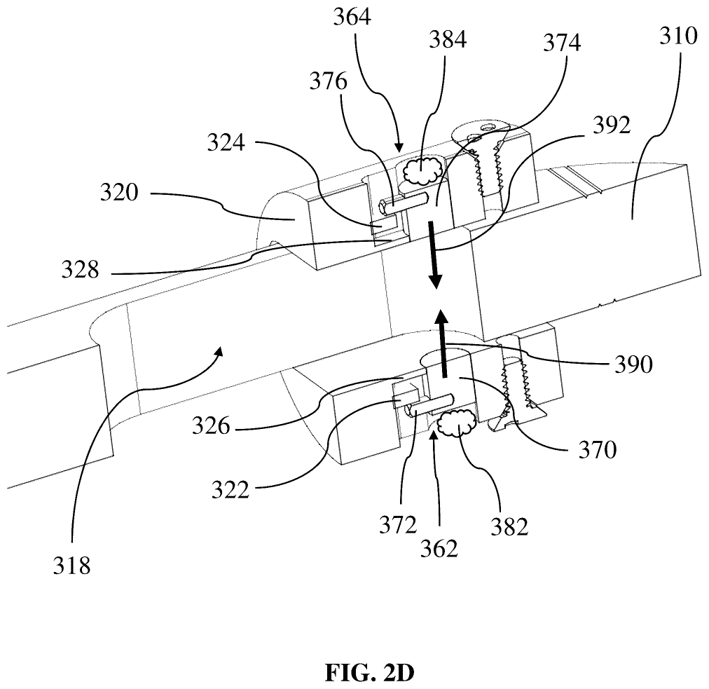

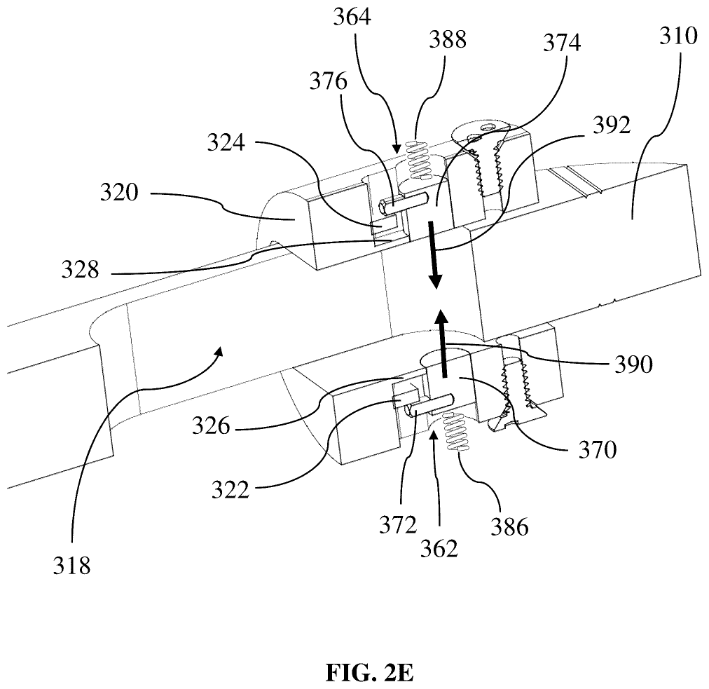

FIG. 2A is a perspective schematic view of a latch mechanism 300 configured for use with the exit device of FIG. 1 where the latch mechanism is located in region 2A of FIG. 1. The latch mechanism 300 includes a latch bolt 310, a first housing 320, and a second housing 330, where the first and second housings may at least partially surround the latch bolt 310. The latch mechanism 300 also includes a biasing member 350 that may be disposed within the second housing 330. The biasing member 350 may be operatively coupled to the latch bolt 310 such that the latch bolt is biased into the extended, latched position absent a force applied by a user on a push bar of the exit device to move the latch bolt to the retracted, unlatched position. For example, the biasing member 350 may be axially arranged around a rod 352 which may at least partially extend through an interior volume of the first housing 320 and/or second housing 330, and the rod 352 may be operatively coupled to each of the latch bolt 310 and the push bar such that movement of the push bar moves the rod 352 downwards to retract the latch against the biasing force of the biasing member 350. The latch mechanism 300 may also include one or more slots 314 formed on a first side 312 of a body of the latch bolt 310. The one or more slots 314 may be configured to receive one or more retaining bolts 342 such that the one or more retaining bolts limit displacement of the latch bolt 310 when moving between the latched position and the retracted position. As shown in FIG. 2A, the retaining bolt 342 may be secured through a retaining clement 340 such that the retaining bolt is slidably disposed within the slot 314. In some embodiments, the retaining element 340 may be integrally formed as a part of the second housing 330. In other embodiments, however, the retaining element 340 may be removably coupled to the second housing 330 such that the retaining element 340 and retaining bolt 342 may be removed to allow for removal of the latch bolt 310.

FIG. 2B is a perspective schematic view of the latch bolt 310 of the latch mechanism of FIG. 2A, where the latch bolt is shown to be surrounded by the first housing 320. As discussed above, the latch bolt 310 may include one or more slots 314 formed on a first side 312 of the latch bolt body. In addition, the latch bolt 310 may include one or more slots 318 formed on a second side 316 of the latch bolt body. In some embodiments, the slots 314, 318 may extend through the body of the latch bolt 310. The first housing 320 may at least partially surround one or more of the slots 318 of the latch bolt 310. The first housing 320 may include one or more recesses 360 which may be configured to receive one or more deployable pins as discussed in greater detail below. The first housing 320 may also include one or more fasteners 380. In some embodiments, the one or more fasteners 380 may be used to secure the first housing to a corresponding push bar of the exit device (not shown). That is, the fasteners may secure a position of the first housing 320 such that the first housing is not permitted to move while the latch bolt 310 is able to move between latched and retracted positions.

FIG. 2C is a cross-sectional schematic view of the latch bolt 310 and first housing 320 of FIGS. 2A-2B taken along lines 2C-2C. As discussed above, the latch bolt 310 may include one or more slots 318 and may be at least partially surrounded by the first housing 320 having one or more recesses 360 formed in the housing. As shown in FIG. 2C, the one or more recesses 360 include a first recess 362 and a second recess 364 which may be positioned opposite one another. Each of the first and second recesses 362, 364 may receive a respective deployable pin 370, 374, and each of the deployable pins 370, 374 may include a respective protuberance 372, 376 that may be configured to abut one or more corresponding blockers 322, 324 positioned within the recess. As disclosed herein, the one or more blockers may be formed integrally with the first housing 320, formed separately and attached to the housing, or otherwise positioned with the recesses 362, 364. As shown in FIG. 2C, the engagement between the protuberances 372, 376 and the blockers 322, 324 may hold the deployable pins 370, 374 in a non-deployed position such that the pins do not extend into the slot 318. In response to the latch mechanism being exposed to a threshold temperature such as in the event of a fire, the deployable pins 370, 374 may be configured to deploy inwardly in the direction of arrows 390 and 392, respectively. In some embodiments, the one or more blockers 322, 324 may melt when exposed to a threshold temperature to permit movement of the pins in the direction of arrows 390, 392. That is, the melting of the blockers may remove a retaining force on protuberances 372, 376, causing the deployable pins to move inwardly until the protuberances contact secondary retaining surfaces 326, 328. Such a configuration may serve to retain the deployable pins partially within the recesses while allowing for a portion of the deployable pins to extend into the slot 318 to retain the latch bolt 310 in the extended, latched position.

In some embodiments, the one or more protuberances 372, 376 may be configured to melt to deploy the deployable pins 370, 374. In some such embodiments, the blockers may not be included and instead the deployable pins may include secondary protuberances (not shown) which may directly contact the secondary retaining surfaces 326, 328 once the first protuberances 372, 376 are melted. In some embodiments, the one or deployable pins may be configured for single-use in response to an elevated temperature event. That is, the deployable pins may not be returned to the non-deployed position and reused. In other embodiments, however, the deployable pins may be reusable for multiple elevated temperature events. For example, the blockers 322, 324 may be replaceable such that new blockers may be positioned within the recesses 362, 364, and the deployable pins may be repositioned such that the protuberances 372, 376 abut the new blockers.

FIG. 2D shows a cross-sectional schematic view of latch bolt 310 similar to that of FIG. 2C, but further shows intumescent materials 382, 384 positioned adjacent to the deployable pins 370, 374, respectively. When the latch mechanism is exposed to a threshold temperature, the intumescent materials 382, 384 may swell to cause the deployable pins to move to the deployed position as indicated by arrows 390, 392. In such an event, the swelling of the intumescent materials may overcome the retaining force between the protuberances 372, 376 and the respective blockers 322, 324, such that the protuberances degrade (e.g., break, melt, etc.), thereby allowing the pins 370, 374 to deploy inwardly. In other embodiments, however, the protuberances 372, 376 and/or the blockers 322, 324 may not be included with the latch bolt. In some such embodiments, the swelling of the intumescent materials 382, 384 may solely cause the pins 370, 374 to move to the deployed position. In this respect, the deployable pins may be held via an interference fit and the swelling of the intumescent materials overcomes the interference fit causing deployment of the deployable pins.

FIG. 2E shows a cross-sectional schematic view of latch bolt 310 similar to that of FIG. 2C, but further shows biasing members 386, 388 positioned adjacent to the deployable pins 370, 374, respectively. The biasing members 386, 388 may be operatively coupled or otherwise engaged with the deployable pins 370, 374 such that the biasing members urge the pins to the deployed position when the latch mechanism is exposed to a threshold temperature. For example, the biasing members 386, 388 may be springs as shown in FIG. 2E which are compressed when the deployable pins 370, 374 are in the non-deployed position, and the protuberances 372, 376 and/or the blockers 322, 324 may be configured to melt or break to cause the deployable pins 370, 374 to move to the deployed position as indicated by arrows 390, 392 upon decompression of the biasing members 386, 388.

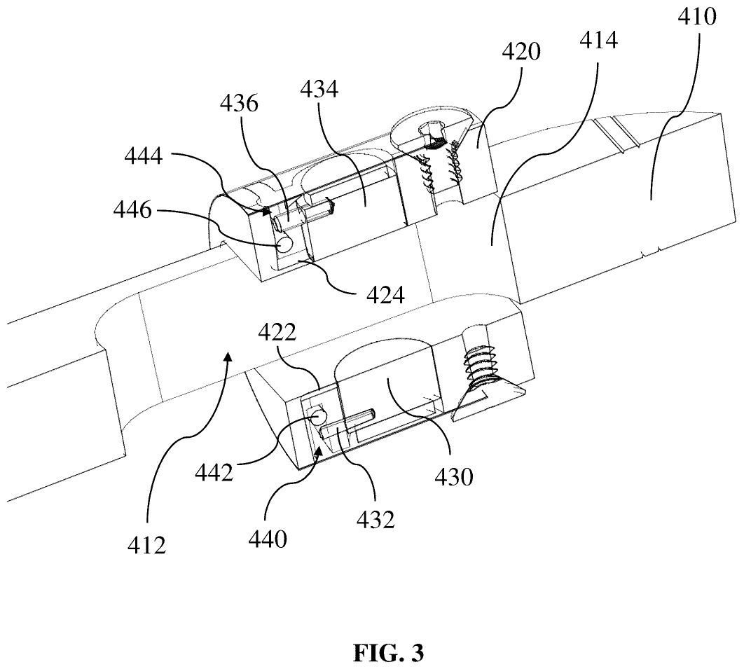

FIG. 3 shows a cross-sectional schematic view of a latch bolt 410 and a housing 420. The latch bolt 410 may include one or more slots 412 and may be at least partially surrounded by the housing 420. One or more deployable pins 430, 434 may be positioned in recesses of the housing 420. Each of the deployable pins may include a respective protuberance 432, 436 extending therefrom. In some embodiments, the protuberances 432, 436 may be formed integrally with the respective deployable pins 430, 434. Alternatively, the protuberances may be fastened or otherwise engaged with the deployable pins. Each of the protuberances 432, 436 may be arranged to contact corresponding blockers 442, 446 to prevent movement of the deployable pins 430, 434 inwardly towards slot 412 formed in the latch bolt 410. As shown in FIG. 3, the blockers 442, 446 may be at least partially received in respective slots 440, 444 of the housing 420 such that the protuberances 432, 436 are unable to move past the blockers due to contact between the blockers and the base of the slots, thereby retaining the deployable pins 430, 434 in the non-deployed position. As shown in FIG. 3, the blockers may be arranged as rods that extend across the slots 440, 444 in a direction transverse (e.g., perpendicular) to the protuberances 432, 436. That is, a longitudinal axis of the rods may be transverse to a longitudinal axis of the protuberances.

In response to the latch mechanism being exposed to a threshold temperature event (e.g., a fire), the blockers 442, 446 may melt, thus removing engagement between the protuberances and blockers and permitting the deployable pins to move inwardly towards the slot 412 to retain the latch bolt in an extended, latched position. In a deployed position of the pins 430, 434, the protuberances 432, 436 may contact secondary retaining surfaces 422, 424 which are formed as a portion of the housing 420. When the pins 430, 434 are in the deployed position, the body of the pins may contact the latch 410 within the slot 412 such that movement of the latch 410 to the retracted, unlatched position is prevented. More specifically, the latch may retract partially from the fully extended position until contact between the pins 430, 434 and the body 414 of latch 410 occurs. In some embodiments, the blockers may be constructed from nylon which may have a lower melting temperature than the deployable pins and protuberances, thus causing the blockers to melt when exposed to the threshold temperature. Although the embodiments described herein primary describe the blockers as being configured to melt to allow movement of the deployable pins, in some embodiments the protuberances may be configured to melt in addition or alternatively to the blockers.

The embodiments described herein may be embodied as a method. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A latch mechanism configured to be secured to a door, the latch mechanism comprising:
a latch bolt that is movable between a latched position and a retracted position, wherein the latch bolt is configured to engage a corresponding door strike when in the latched position; and
one or more deployable pins configured to move to a deployed position in response to the latch mechanism being exposed to a threshold temperature,
wherein the one or more deployable pins are configured to retain the latch bolt in the latched position when the one or more deployable pins are in the deployed position.

2. The latch mechanism of claim 1, further comprising a housing configured to at least partially surround the latch bolt.

3. The latch mechanism of claim 2, further comprising one or more recesses formed in the housing, wherein the one or more recesses are configured to receive the one or more deployable pins.

4. The latch mechanism of claim 2, further comprising one or more blocking elements disposed on the housing, wherein the one or more blocking elements are configured to engage the one or more deployable pins to prevent the one or more deployable pins from moving to the deployed position absent exposure of the one or more deployable pins to the threshold temperature.

5. The latch mechanism of claim 4, further comprising one or more protuberances extending from each of the one or more deployable pins, wherein the one or more protuberances are configured to engage the one or more blocking elements to prevent movement of the one or more deployable pins to the deployed position.

6. The latch mechanism of claim 5, wherein the one or more blocking elements are configured to melt when exposed to the threshold temperature to permit movement of the one or more deployable pins to the deployed position.

7. The latch mechanism of claim 5, wherein the one or more protuberances are configured to melt when exposed to the threshold temperature to permit movement of the one or more deployable pins to the deployed position.

8. The latch mechanism of claim 1, wherein the one or more deployable pins are two deployable pins positioned opposite to one another.

9. The latch mechanism of claim 1, further comprising at least one biasing member operatively engaged with the one or more deployable pins, wherein the at least one biasing member is configured to bias the one or more deployable pins to the deployed position.

10. The latch mechanism of claim 3, further comprising at least one intumescent material disposed in the one or more recesses, wherein the at least one intumescent material is configured to move the one or more deployable pins to the deployed position when exposed to the threshold temperature.

11. The latch mechanism of claim 1, further comprising one or more slots disposed on the latch bolt, and further comprising a retaining bolt slidably disposed within one of the one or more slots, wherein the retaining bolt is configured to limit displacement of the latch bolt when moving between the latched position and the retracted position.

12. The latch mechanism of claim 1, further in combination with an exit device, wherein the exit device includes a push bar, wherein the push bar is moveable between and extended position and a depressed position, and wherein moving the push bar to the depressed position moves the latch bolt to the retracted position.

13. The latch mechanism of claim 1, further comprising one or more blocking elements configured to contact and prevent movement of the one or more deployable pins absent exposure of the one or more deployable pins to the threshold temperature.

14. The latch mechanism of claim 13, further comprising one or more protuberances extending from each of the one or more deployable pins, wherein the one or more protuberances are configured to engage the one or more blocking elements to prevent movement of the one or more deployable pins to the deployed position.

15. The latch mechanism of claim 14, wherein a longitudinal axis of the one or more blocking elements is transverse to a longitudinal axis of the one or more protuberances.

16. The latch mechanism of claim 13, further comprising a housing configured to at least partially surround the latch bolt, and wherein one or more slots are formed in the housing and configured to at least partially receive the one or more blocking elements.

17. The latch mechanism of claim 1, wherein the threshold temperature is between or equal to 125° F. and 300° F.
